(19) United States
(12) Patent Application Publication
(10) Pub. No.: US 2003/0224860 A1
(43) Pub. Date: Dec. 4, 2003

(54) Constant velocity joints

(76) Inventor: Hyuk Choon Yun, Siheung-si (KR)

Correspondence Address: Pennie & Edmonds, LLP, 3300 Hillview Avenue, Palo Alto, CA, 94304, US

(21) Appl. No.: 10/306,652

(22) Filed: Nov. 26, 2002

(30) Foreign Application Priority Data
Jun. 4, 2002 (KR) 2002-31377

(51) Int. Cl. F16D 3/26; F16D 3/50

(52) U.S. Cl. 464/125

(57) ABSTRACT

A housing has trunnions installed at three positions, equiangularly around an inner circumferential surface of the housing. Bearings are coupled to respective trunnions and rollers are coupled to the outsides of the respective bearings. A driving axle, in which an insert with grooves on an outer periphery thereof, is coupled to an end of the driving axle so that the driving axle can be coupled into the housing. According to embodiments of the present invention, vibration associated with constant velocity joints can be effectively reduced by causing the sliding friction force of the roller with respect to the trunnion to be transmitted to the housing, such that the friction force is cancelled in the transmission side.

### FIELD OF THE INVENTION

The present invention relates to a constant velocity joint, and more particularly, to reducing vibration of a tripod constant velocity joint for use in a driving axle of a vehicle.

### BACKGROUND OF THE INVENTION

A constant velocity joint allows driving and driven axles to operate smoothly at identical velocities even though an intersection angle between the driving and driven axles is increased. In general, the constant velocity joint is spline-coupled to a driving axle of a front wheel drive vehicle or a rear differential side gear in an independent suspension system.

The driving axle of the vehicle is generally provided with two constant velocity joints with a portion coupled to a transmission side and a portion coupled to a wheel side.

In the conventional tripod joint, a bearing is interposed between a roller assembly and a trunnion assembly. The assemblies of the roller, the trunnion and the bearing are installed equiangularly at three positions onto a driving axle. The assembly is then coupled within a housing which is itself coupled to a transmission. In use, as the housing is rotated, the roller is rotated, and consequently the driving axle is rotated. Thus, a driving force from the transmission side is transmitted to the driving axle at a constant velocity.

However, vibration is often produced in the vehicle due to an axial force transmitted to the driving axle.

In use, a front portion of the vehicle becomes “nose up” due to an increase in engine torque upon low-speed acceleration. This results in an increase in the intersection angle between the driving axle and the housing. The axial force results in vibration of the vehicle because a friction force is created between the roller and a groove of the housing in a direction of the trunnion, and also between the roller and the trunnion.

Vibrationless joints have been attempted. However, prior attempts at such joints have not solved the problem. This is because vibrationless joints generate a force component corresponding to the friction force between the roller and the trunnion which is transmitted directly to the driving axle. Therefore, the axial force is not completely reduced and vibration remains in the system. Furthermore, conventional vibrationless joints are expensive.

### SUMMARY OF THE INVENTION

Embodiments of the present invention provide cost effective structures that reduce vibration generated in a constant velocity joint.

Vibration can be reduced according to the invention, inter alia, by causing sliding friction forces between the rollers and the trunnions to be transmitted, not to a driving axle, but to a housing. Thus, the friction forces can be cancelled in the transmission side. Furthermore, no additional spline processing is required since grooves formed in an insert can be manufactured through the forging process.

According to one embodiment of the present invention a housing is made in the form of a substantially cylindrical shell. Trunnions are installed at three positions equiangularly on an inner circumferential surface of the housing, and bearings coupled to the respective trunnions. Rollers are also coupled to the outsides of the respective bearings, and a driving axle comprising an insert with three grooves formed equiangularly on an outer periphery thereof, such that the axle can be coupled into the housing with the rollers installed therein.

### BRIEF DESCRIPTION OF THE DRAWINGS

Advantages and features of the present invention will become apparent from the following description given in conjunction with the accompanying drawings, in which:

FIG. 1 is a perspective view of a constant velocity joint according to an embodiment of the present invention;

FIG. 2 is a side view of the constant velocity joint according to an embodiment of the present invention; and

FIG. 3 is a cross-sectional view taken along line A-A of FIG. 2.

### DETAILED DESCRIPTION OF THE INVENTION

Hereinafter, a preferred embodiment of the present invention will be explained in detail with reference to the accompanying drawings.

As shown in the figures, a constant velocity joint of the present invention comprises a housing 10. Trunnions 20 are installed, preferably, at three positions equiangularly in an inner circumferential region of the housing 10. The inner circumferential region being the area within the interior of the housing 10. Bearings 30 are then coupled to the respective trunnions 20 and rollers 40 are coupled to the outside of the respective bearings 30. A driving axle 50, in which an insert 52 with grooves 51 formed at three positions equiangularly on an outer periphery thereof, is coupled to an end of the axle, such that the axle can be coupled into the housing 10 with the rollers 40 installed therein.

The rolling surfaces of the rollers 40 make contact with the groves 51. Both surfaces, the rolling surface of the rollers 40 and the roller receiving surface of the grove 51 are substantially spherical. A friction force, due to rolling action of each roller 40 is therefore minimized so that any axial motions are not produced in the driving axle 50.

Further, the trunnions 20 are fitted into holes formed equiangularly along a circumference of the housing 10, and then fixed thereto through, for example, a press-fit process, with an adhesive, or the like. Thereafter, the bearings 30 and the rollers 40 are sequentially installed around the trunnions 20 fixed to the housing 10.

It is preferred that a needle bearing in the form of the cylindrical shell for surrounding the trunnion 20 is used as the bearing 30.

Preferably, each of the trunnions 20 further comprise a spacer 21 for preventing the bearing 30 from coming into contact with the relevant groove 51 of the insert 50.

The grooves 51, formed in the insert 52, can be manufactured, for example, through a general forging process. Thus, any additional spline processing is not needed.

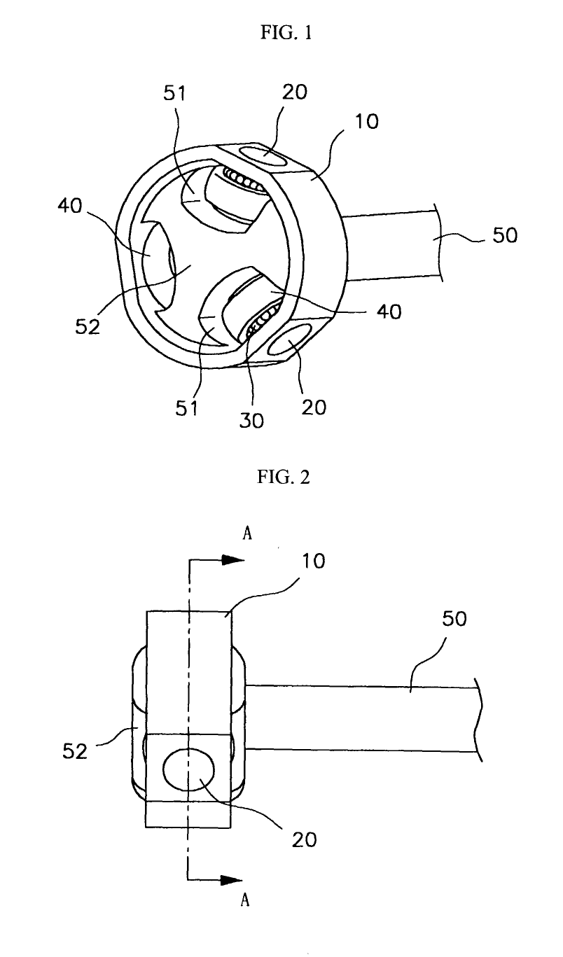

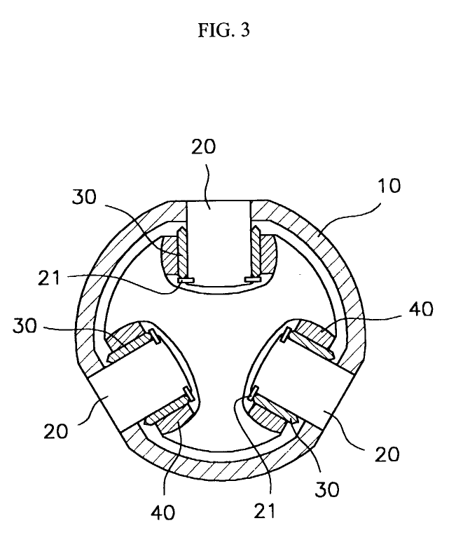

Hereinafter, an operation and effect of the present invention will be described with reference to FIGS. 1-3. Sliding friction force with respect to the trunnion 20 is basically transferred to the housing 10 rather than the driving axle 50, so that it can be cancelled in a transmission side. In use, friction force between the roller 40 and the bearing 30, rotational friction force between the roller 40 and the housing with respect to an axis of the trunnion 20, and axial (linear) friction force between the roller 40 and the housing with respect to the axis of the trunnion 20 is decreased, and a spin force of the roller 40 is also reduced. Therefore, an amount of the axial force to be transmitted to the driving axle 50 is decreased, and thus, the vibration of the vehicle is reduced.

Although the present invention has been described in connection with the preferred embodiment with reference to the accompanying drawings, the preferred embodiment is intended not to limit the invention but to exemplify a best mode of the present invention. It will be understood by those skilled in the art that various changes or modifications may be made thereto without departing from the spirit and scope of the invention. Therefore, the present invention is defined only by the appended claims which should be construed as covering such changes or modifications.

What is claimed is:

1. A constant velocity joint, comprising:
a housing made in the form of a cylindrical shell;
trunnions installed at three positions equiangularly on an inner circumferential surface of the housing;
bearings coupled to the respective trunnions;
rollers coupled to the respective bearings, and
a driving axle in which an insert with three grooves formed equiangularly on an outer periphery thereof is coupled to an end of the axle so that the axle can be coupled into the housing with the rollers installed therein.

2. The constant velocity joint as claimed in claim 1, wherein rolling surfaces of the rollers and contact surfaces of the grooves with the rollers are formed to be spherical.

3. The constant velocity joint as claimed in claim 1, wherein the trunnions are fitted into holes formed equiangularly along a circumference of the housing and then fixed thereto through a press-fit process or with an adhesive.

4. The constant velocity joint as claimed in claim 1, wherein each of the trunnions further includes a spacer for preventing the bearing from coming into contact with the relevant groove of the insert.

5. A constant velocity joint, comprising:
a housing having an inner circumferential region;
at least three trunnions positioned equiangularly within said inner circumferential region of said housing;
at least one bearing configured to couple over said trunnion;
rollers configured and dimensioned to couple over said bearing; and
an insert configured and dimensioned to receive said rollers and be received by said inner circumferential region of said housing, and wherein said insert is coupled to a driving axle.

6. The constant velocity joint of claim 5, wherein said rollers are configured with an outer surface that is substantially spherical.

7. The constant velocity joint of claim 5, wherein said insert has substantially spherical groves configured and dimensioned to receive said substantially spherical outer surface of said rollers.

8. The constant velocity joint of claim 5, further comprising spacers configured and dimensioned to prevent said bearing from contacting said insert.

9. The constant velocity joint of claim 5, wherein said housing defines equiangularly positioned holes therethrough into which said trunnions are inserted for coupling to said inner circumferential region of said housing.
